(19) United States
(12) Patent Application Publication
(10) Pub. No.: US 2016/0156779 A1
(43) Pub. Date: Jun. 2, 2016

(54) NON-CONTACT STRESS ASSESSMENT DEVICES

(71) Applicant: Xerox Corporation, Norwalk, CT (US)

(72) Inventors: Om Dadaji DESHMUKH, Bangalore (IN); Nischal Murthy PIRATLA, Fremont, CA (US); Lalit Keshav MESTHA, Fairport, NY (US)

(21) Appl. No.: 15/014,188

(22) Filed: Feb. 3, 2016

Related U.S. Application Data
(63) Continuation of application No. 14/217,962, filed on Mar. 18, 2014, now Pat. No. 9,270,825.

(51) Int. Cl. H04M 3/51; G06T 7/00

(52) U.S. Cl. CPC H04M 3/5175; G06T 7/0012; G06T 2207/30088

(57) ABSTRACT

Embodiments of a system are disclosed for stress assessment of a call center agent while interacting with a customer. The system is for use with a communication network. The system includes a stress assessment device and an agent device that includes an imaging unit. The agent device is configured to capture video of a target region of exposed skin of the agent using the imaging unit, collect customer interaction data based on interaction with a customer device over the communication network, and communicate the captured video and the customer interaction data to the stress assessment device. The stress assessment device is configured to passively estimate agent stress-level based on the received video, and generate feedback to the agent based on correlation between the customer interaction data and the estimated stress-level over a predefined time interval.

### CROSS REFERENCE TO RELATED APPLICATIONS

This patent application is a continuation of commonly owned and co-pending U.S. patent application Ser. No. 14/217,962, entitled: “Non-Contact Stress Assessment Devices”, by Om D. Deshmukh et al., filed Mar. 18, 2014.

### TECHNICAL FIELD

The presently disclosed subject matter relates to call center technologies, and more particularly to non-contact stress assessment technologies.

### BACKGROUND

The human body experiences stress due to a wide range of physiological and psychological external stimuli. Stress enables an active physiological response of the body to the external stimuli in a timely fashion. However, an abnormal increase in stress may compromise long-term health and disrupt the body's ability to respond to events that require a quick physical response, such as quickly pulling a hand away from a hot flame.

In a call center environment, agents often experience stress when communicating with customers for various reasons. For example, agents may experience stress when dealing with irate customers, or when the agent's role is either in conflict or ambiguous. Agent role conflict occurs when an agent has conflicting objectives to meet, such as where the agent is evaluated on the number of calls answered in a day. However, the agent may be simultaneously expected to resolve each caller's query/concern, which may result in calls lasting longer and thus decreasing the number of calls answered in a day. Agent role ambiguity occurs when the agent is either unaware of an appropriate action for a customer query, or lacks sufficient information for resolving the query. For example, customer complaints are usually related to inherent issues with respect to a client's product or service, over which the agent has little or no control (e.g., outage in access to a website due to annual maintenance). In another example, the agent may not have enough information to resolve a customer concern (e.g., the troubleshooting manual does not cover a particular type of problem), what is needed in this art are sophisticated systems and methods for.

### BRIEF SUMMARY

Various measures are traditionally applied in a call center to improve customer care, as well as each agent's efficiency and work satisfaction. A few examples of these measures include collection of data related to audio analysis of the call, agent-generated call summaries, customer-provided feedback, and interactive voice response (IVR) call routing. The collected data is manually analyzed, such as by a supervisor, to identify customer issues and agent performance areas that need improvement. This data can also be used to help the agent by either reducing the agent call flow or to provide relevant assistance to the agent. The time delay due to offline analyses of the collected data impedes or prevents the supervisor from effectively monitoring multiple calls in a live environment to ensure or enhance customer satisfaction. Additionally, the agent's stress-level during a customer call is not taken into consideration to perform the above analyses. As a result, the related art fails to provide appropriate long-term remedial solutions for the agent to improve performance and work satisfaction.

It may therefore be beneficial to provide a reliable solution that provides real-time feedback on an interaction between an agent and a customer based on the agent stress-level during a live customer call.

One exemplary embodiment includes a system for stress assessment of a call center agent while interacting with a customer. The system is for use with a communication network. The system includes a stress assessment device and an agent device that includes an imaging unit. The agent device is configured to: (1) capture video of a target region of exposed skin of the agent using the imaging unit; (2) collect customer interaction data based on interaction with a customer device over the communication network; and (3) communicate the captured video and the customer interaction data to the stress assessment device. The stress assessment device is configured to: (1) passively estimate agent stress-level in real-time based on the received video; and (2) generate feedback to the agent based on correlation between the customer interaction data and the estimated stress-level over a predefined time interval.

Another exemplary embodiment includes a device for generating feedback to a call center agent during communication with a customer. The device includes a video analysis module, a customer interaction module, and a feedback module. The video analysis module receives a video of a target region of exposed skin of the agent. The video analysis module is configured to passively estimate stress-level of the agent based on the received video over a predefined time interval. The customer interaction module for receiving data collected based communication between the agent and the customer. The customer interaction module is configured to correlate the data with the estimated stress-level over the predefined time interval. The feedback module configured to generate feedback to the agent in real-time based on the estimated stress-level exceeding a predefined stress threshold. The generated feedback includes suggestive messages based on the correlated data.

Yet another exemplary embodiment includes a method for generating feedback during interaction between an agent and a customer. The method includes receiving customer interaction data and video of a target region of exposed skin of the agent. The method also includes processing the video to generate a time-series signal and to extract low frequency and high frequency components from the generated time-series signal. The method further includes determining stress profile of the agent based on a ratio of the low frequency components and the high frequency components of the integrated power spectrum of the time-series signal over a predefined time interval, such that the ratio exceeds a predefined stress threshold. The method furthermore includes correlating the customer interaction data with the determined stress profile, and identifying agent stress-trigger points based on the correlated customer interaction data. The method also includes generating feedback based on the determined stress profile in real-time. The generated feedback includes suggestive predefined remedial messages based on the identified agent stress-trigger points.

Still another exemplary embodiment includes a computer-readable medium comprising computer-executable instructions for generating feedback during interaction between an agent and a customer. The computer-readable medium including instructions for receiving customer interaction data and video of a target region of exposed skin of the agent, and processing the video to generate a time-series signal and to extract low frequency and high frequency components from the time-series signal. The computer-readable medium also includes instructions for determining stress profile of the agent based on a ratio of the low frequency components and the high frequency components of the integrated power spectrum of the time-series signal over a predefined time interval such that the ratio exceeds a predefined stress threshold. The computer-readable medium further includes instructions for correlating the customer interaction data with the determined stress profile, and identifying agent stress-trigger points based on the correlated customer interaction data. The computer-readable medium also includes instructions for generating feedback based on the determined stress profile in real-time. The generated feedback includes suggestive predefined remedial messages based on the identified agent stress-trigger points.

Other and further aspects and features of the disclosure will be evident from reading the following detailed description of the embodiments, which are intended to illustrate, not limit, the present disclosure.

### BRIEF DESCRIPTION OF THE DRAWINGS

FIGS. 1-4 illustrate exemplary network environments including a stress assessment device, according to embodiments of the present disclosure;

FIG. 5 illustrates an exemplary stress assessment device, according to an embodiment of the present disclosure;

FIG. 6 is a table summarizing spectral components of various heart rate (HR) signals for explanatory purposes; and

FIG. 7 illustrate an exemplary method for implementing the stress assessment device of FIG. 5, according to an embodiment of the present disclosure.

### DETAILED DESCRIPTION

The following detailed description is made with reference to the figures. Exemplary embodiments are described to illustrate the disclosure, not to limit its scope, which is defined by the claims.

Those of ordinary skill in the art will recognize a number of equivalent variations in the description that follows.

### NON-LIMITING DEFINITIONS

In various embodiments of the present disclosure, definitions of one or more terms that will be used in the document are provided below.

A “video” is a time-varying sequence of images captured of a subject of interest using a video camera capable of acquiring a video signal over at least one data acquisition (imaging) channels. The video may also contain other components such as, audio, time reference signals, and the like.

A “time-series signal” refers to a time varying signal generated from images of the captured video. Time-series signals may be generated in real-time from a streaming video as in the case of continuous call center agent monitoring. The time-series signal may be obtained directly from the data acquisition channel of the video camera used to capture the video of the subject of interest. The time-series signal may be retrieved from a remote device such as a computer workstation over a wired or wireless network or obtained on a continuous basis from a video stream.

“Cardiac pulse” is a pressure wave that is generated by the subject's heart (in systole) as the heart pushes a volume of blood into the arterial pathway. Arterial movement, as a result of this pressure wave, can be sensed by tactile and electronic methods. A frequency range of the cardiac pulse is the pulse rate measured over time, typically recorded in beats per minute (bpm) with upper and lower limits. The frequency range of the human cardiac pulse is between about 40 bpm to 240 bpm. A resting adult human, typically aged 18+ years has a heart rate of 60 to 100 bpm. For an adult athlete, the resting heart rate will be 40 to 60 bpm. The frequency range of the cardiac pulse for animals also varies in a similar manner. For example, a cat has a cardiac pulse of 120 to 140 bpm, a mouse has a cardiac pulse of 450 to 750 bpm and an elephant has a cardiac pulse of 25 to 35 bpm. Each species has its own cardiac pulse frequency range and thus its own “normal” heart rate. Cardiac output, i.e., the volume of blood the heart can pump in one minute which is expressed in L/min (.about.5.6 L/min for an adult human male and 4.9 L/min for an adult human female) and is proportional to heart rate.

The numerous references in the disclosure to a stress assessment device are intended to cover any and/or all devices capable of performing respective operations on the person in a customer-interacting environment relevant to the applicable context, regardless of whether or not the same are specifically provided.

### Exemplary Embodiments

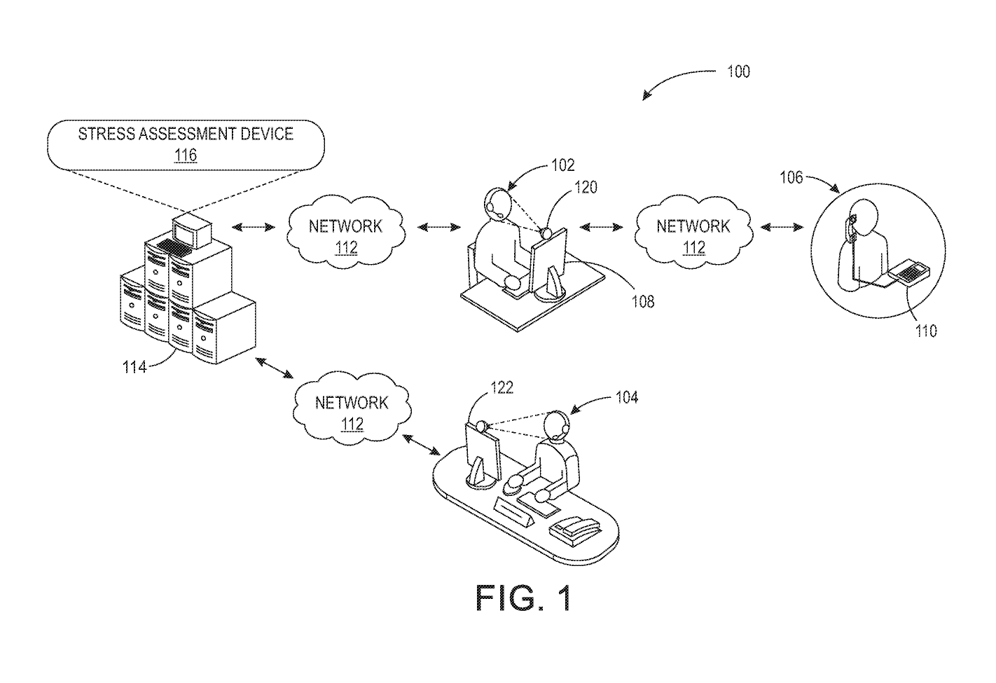

FIGS. 1-4 illustrate exemplary network environments including a stress assessment device 116, according to some exemplary embodiments of the present disclosure. Some embodiments are disclosed in the context of network environments that represent a communication pathway for a call center to enhance interaction among a call center agent 102, a call center supervisor 104, and a customer 106. However, other embodiments can be applied in the context of other business scenarios involving interactions between different entities including customers, employees, colleagues, vendors, consultants, and so on. Examples of such scenarios include, but are not limited to, bank agents handling customer account workflows or related processes, hospital agents handling patient documents (such as in the context of new patients in emergency situations), healthcare professionals handling patient interactions in a tele-health environment, retail agents handling customer's return counters, teachers or students handling coursework, etc.

The agent 102 and the customer 106 may communicate with each other using an agent device 108 and a customer device 110, respectively, in different network environments. The agent device 108 may be implemented as any of a variety of computing devices, including, for example, a server, a desktop PC, a notebook, a workstation, a personal digital assistant (PDA), a mainframe computer, a mobile computing device, an internet appliance, and so on. The agent device 108 is configured to exchange at least one of text messages, audio interaction data (e.g., voice calls, recorded audio messages, etc.), and video interaction data (e.g., video calls, recorded video messages, etc.) with the customer device 110, or in any combination thereof. The customer device 110 may include calling devices (e.g., a telephone, an internet phone, etc.), texting devices (e.g., a pager), or computing devices including those mentioned above.

In a first exemplary network environment 100 (FIG. 1), the agent device 108 may be configured to interact directly with the customer device 110 via a network 112. The network 112 may be a wireless or a wired network, or a combination thereof. The network 112 may be a collection of individual networks, interconnected with each other and functioning as a single large network (e.g., the Internet or an intranet). Examples of the network 112 include, but are not limited to, local area network (LAN), wide area network (WAN), cable/telephone network, satellite network, and so on.

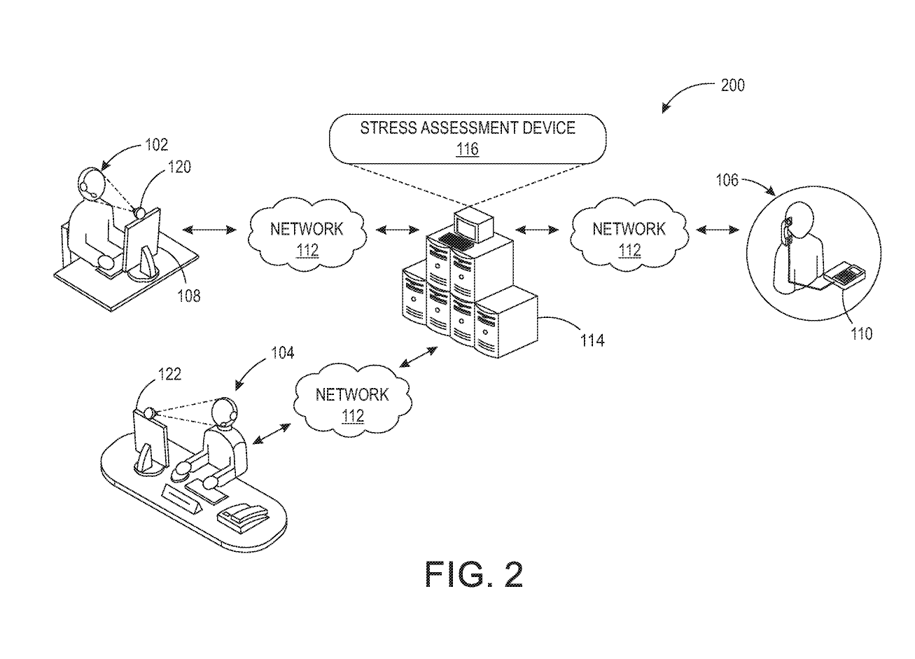

The agent device 108 may collect a variety of customer interaction data during communication with the customer device 110. For example, the agent device 108 may be installed with a known, related art or later developed interactive voice response (IVR) system (not shown). The IVR system interfaces with the customer device 110 before the customer 106 can interact with the agent 102 through various modes, such as text messages, audio interactions (e.g., voice calls, recorded audio messages, etc.), and video interactions (e.g., video calls, recorded video messages, etc.). However, in a second exemplary network environment 200 (FIG. 2), the agent device 108 may be configured to interact with the customer device 110 via a server 114. The server 114 may connect the agent device 108 to the customer device 110 over the network 112. Optionally, the IVR system may be installed on the server 114 for interfacing with the customer device 110. The server 114 may be implemented as any of a variety of computing devices including, for example, a general purpose computing device, multiple networked servers (arranged in clusters or as a server farm), a mainframe, or so forth.

The customer 106 may submit voice inputs or dual tone multi-frequency (DTMF) tone inputs to the IVR system using the customer device 110 in response to prerecorded or dynamically generated audio messages in the IVR system. Subsequently, the customer 106 may be routed via the IVR system to the agent device 108 for interacting with the agent 102. However, other examples may include one or more agent devices configured to establish a direct communication with the customer devices for exchanging text messages, audio interaction data, and video interaction data without the IVR system. The agent device 108 may convey the customer interaction data including the text messages, the audio interaction data, and the video interaction data conducted between the customer 106 and the agent 102 (or the supervisor 104), agent-generated customer call summaries after communication with the customer 106, customer-provided feedback and customer's responses to the IVR audio messages, to the server 114. The agent device 108 is configured to provide agent identification data along with the customer interaction data to the server 114. Examples of the agent identification data include, but are not limited to, agent login ID, agent name, IP address of the agent device 108, and so on. In some embodiments, the agent device 108 may tag the agent identification data with the customer interaction data. The server 114 includes a stress assessment device 116 for analyzing the customer interaction data received from the agent device 108 (FIG. 1) or the customer device 110 (FIG. 2). Along with the customer interaction data, the server 114 also receives the corresponding agent identification data from the agent device 108.

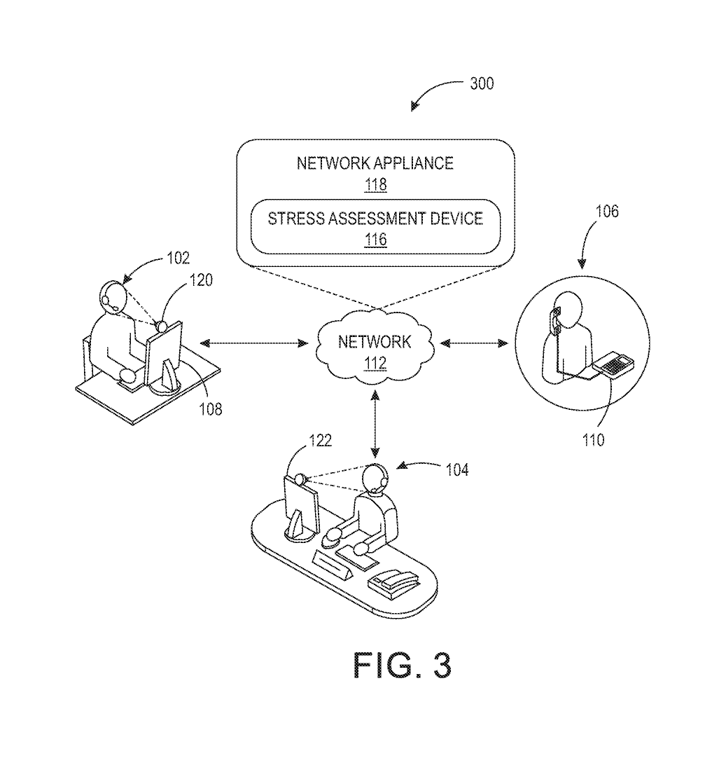

Similar to the network environment 100 (FIG. 1), a third exemplary network environment 300 (FIG. 3) may implement the agent device 108 to interact with the customer device 110 over the network 112. In one embodiment, the network 112 may be established using a network appliance 118 that may be integrated with the stress assessment device 116. In other embodiments, the network appliance 118 may be preconfigured or dynamically configured to include the stress assessment device 116 integrated with other devices. For example, the stress assessment device 116 may be integrated with the agent device 108. The agent device 108 may include a module (not shown) that enables the agent device 108 being introduced to the network appliance 118, thereby enabling the network appliance 118 to invoke the stress assessment device 116 as a service. Examples of the network appliance 118 include, but not limited to, a DSL modem, a wireless access point, a router, and a gateway for implementing the stress assessment device 116.

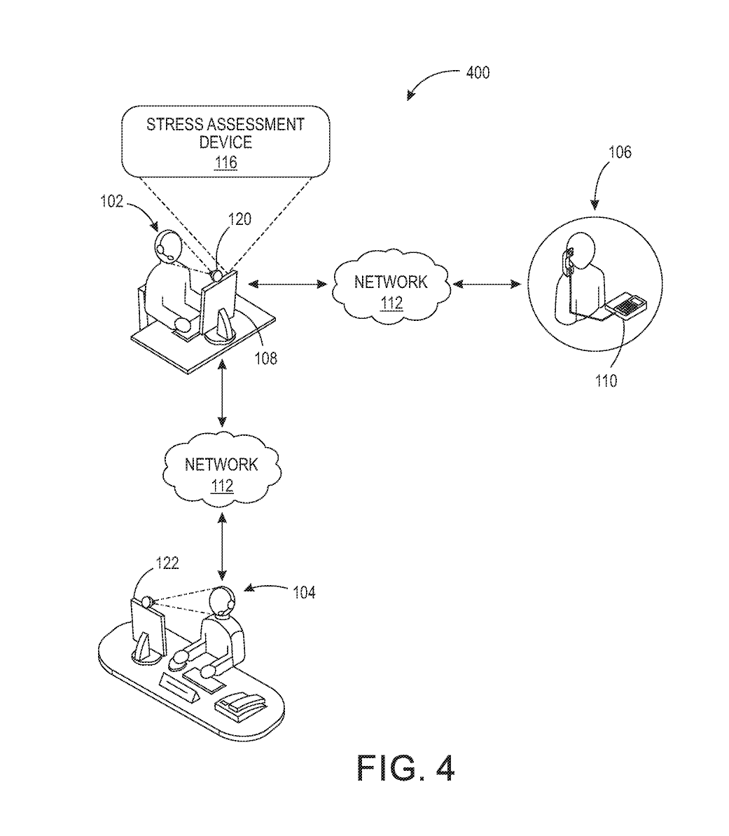

The stress assessment device 116 may represent any of a wide variety of devices that provide services for the network 112. The stress assessment device 116 may be implemented as a standalone and dedicated “black box” including hardware and installed software, where the hardware is closely matched to the requirements and/or functionality of the software. The stress assessment device 116 may enhance or increase the functionality and/or capacity of the network 112 to which it is connected. The stress assessment device 116 may be configured, for example, to perform e-mail tasks, security tasks, network management tasks including IP address management, and other tasks. In some embodiments, the stress assessment device 116 is configured not to expose its operating system or operating code to an end user, and does not include related art I/O devices, such as a keyboard or display. The stress assessment device 116 of some embodiments may, however, include software, firmware or other resources that support remote administration and/or maintenance of the stress assessment device 116. Alternatively, as shown in a fourth exemplary network environment 400 (FIG. 4), the stress assessment device 116 may be integrated with, or installed on, the agent device 108 that directly communicates with the customer device 110 over the network 112. The stress assessment device 116, discussed below in greater detail, may be configured to estimate stress-levels of multiple agents, such as the agent 102, upon receiving their videos and generate feedback on real-time or at predetermined intervals to corresponding agents about the estimated stress-levels.

Further, the agent device 108 may include an imaging unit 120, such as a camera, operating in communication with the agent device 108. In a first example, the imaging unit 120 includes a color video camera such as an HD webcam with at least one imaging channel for capturing color values for pixels corresponding generally to the primary visible colors (typically RGB). In a second example, the imaging unit 120 is an infrared camera with at least one imaging channel for measuring pixel intensity values in the near-infrared (NIR) wavelength range. In a third example, the imaging unit 120 is a hybrid device capable of capturing both color and NIR video. In a fourth example, the imaging unit 120 is a multi/hyper spectral camera device capable of capturing images at multiple wavelength bands.

The imaging unit 120 may be configured for capturing video of the agent 102 being monitored. The imaging unit 120 may be rotatable about a fixed support, such as the agent device 108, so that a field of view of the imaging unit 120 is directed to a region of interest on the agent's body with exposed skin area. The region of interest is an unobstructed area of a region of agent's skin where a photoplethysmograph (PPG) signal (discussed later in greater detail) of the agent 102 can be registered. Such regions may be identified in image frames of the captured video using, for example, object identification, pixel classification, material analysis, texture identification, pattern recognition methods, etc. The region of interest on the agent's body may be exposed to the ambient surroundings. The region of interest that is chosen for analysis is relatively small, for example, the forehead, middle of the chest, etc., rather than the entire visible region of the agent's body, to reduce or avoid variability in analyses that may be caused by anatomical and physiological functions or movements of various body parts. The imaging unit 120 may simultaneously monitor multiple agents based on the field of view and resolution of the unit 120.

The imaging unit 120 provides the captured video of the region of interest (ROI) to the agent device 108. The agent device 108 combines the captured video with the agent identification data and sends both the captured video and the agent identification data to the stress assessment device 116. The stress assessment device 116 receives the agent's ROI video and processes it to generate a time-series signal containing a photoplethysmograph (PPG) signal for analyses. The stress assessment device 116 is configured to provide real-time feedback to the agent device 108 or a supervisor device 122 associated with the supervisor 104 based on the agent stress exceeding a predefined threshold during a live customer interaction. The stress assessment device 116 analyzes the generated time-series signal to estimate the stress-levels of the agent 102 ‘passively’ through any known, related art or later developed non-contact mechanisms, while a customer-agent interaction is in progress. For example, heart rate variability (HRV) is a common measure that may be used for evaluating agent stress by determining state of the autonomic nervous system (ANS) of the agent 102. The ANS is represented by the sympathetic nervous system (SNS) and the parasympathetic nervous system (PNS) of the agent 102. HRV is the beat-to-beat time variation in heartbeat and is modulated by changes in the balance between influences of the SNS and the PNS. Such changes occur based on the response of the agent's body to stress by releasing hormones, such as epinephrine and cortisol, which in turn lead to increase in heartbeat, tightening of muscles, and increase in blood pressure. HRV is also useful for diagnosis of various diseases and health conditions such as diabetic neuropathy, cardio vascular disease, myocardial infraction, fatigue, sleep problems, psychiatric disorders, psychological disorders, etc.

In an embodiment, the stress assessment device 116 extracts and analyses a ratio of low-frequency (LF) and high-frequency (HF) components of the integrated power spectrum of the generated time-series signal. When the LF/HF ratio is greater than a stress threshold value, for example, a value ‘1’, the agent's SNS is more dominant and hence indicates that the agent 102 is under stress. Accordingly, the stress assessment device 116 generates feedback to the agent device 108 (or the supervisor device 122), as identified by the agent identification data, so that the agent 102 or the supervisor 104 may take appropriate action to reduce the agent stress. Additionally, an increasing level of agent stress based on the increasing LF/HF ratio may be assessed with respect to multiple predefined stress thresholds to create a stress profile for each agent 102 in real-time. Whenever the LF/HF ratio exceeds each of the predefined stress thresholds, feedback may be generated by the stress assessment device 116, discussed later in greater detail. Such stress profiles of different agents may be used, such as by the supervisor 104, for various purposes. For example, the agent stress profiles may assist the supervisor 104 to identify a set of agents that may be appropriate for: (1) a particular customer concern or issue; (2) further training on particular customer concerns or issues; (3) customer concerns or issues that need better training material for the agents, and so on. Such analyses of the time-series signal enables the integration of multiple sources of data, such as the agent's body motion; the customer's audio responses to the agent 102 or the IVR system; color or textual changes in the exposed skin area of the agent 102; etc., to enhance diagnosis of HRV and interactions with other effects of ANS.

Further, the stress assessment device 116 is configured to analyze the customer interaction data based on various parameters. Examples of these parameters include, but are not limited to, key words (e.g., ‘hello’, ‘late’, ‘hurry’, etc.), generic terms of interest (e.g., 16-character alphanumeric customer ID, 10-digit phone number, etc.), sentiment-intensive words (e.g., ‘hate’, ‘irritate’, etc.), user selections on the IVR system to identify a broad topic of a customer-agent conversation, customer-agent voice-over that may be indicative of impatience and irritation for the customer 106, and other finer aspects of the customer-agent interaction.

The stress assessment device 116 then correlates the analyzed customer interaction data for each parameter with the determined stress profile for each agent 102 based on the agent identification data to identify stress-trigger points. The stress assessment device 116 is configured to generate predefined suggestive remedial messages based on the identified stress-trigger points. The stress assessment device 116 may be configured to communicate, either automatically or upon request, the predefined remedial messages along with the feedback, or otherwise, to the corresponding agent device 108 and/or the supervisor device 122. The predefined suggestive remedial messages assist the agent 102 and the supervisor 104 on-the-fly to undertake appropriate actions to reduce agent stress during live communication with the customer 106.

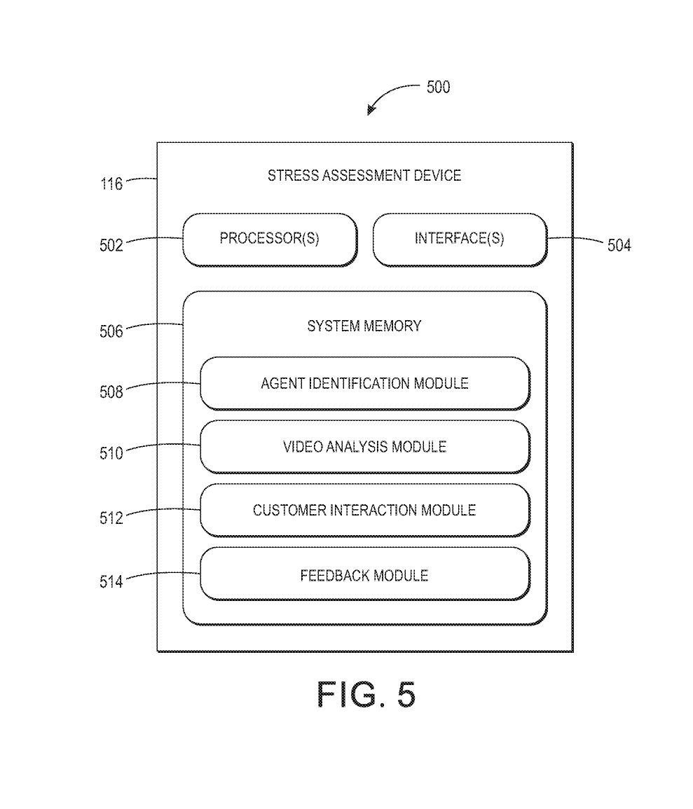

FIG. 5 includes an exemplary stress assessment device according to an embodiment of the present disclosure. The stress assessment device 116 includes one or more processors 502, one or more interfaces 504, and a system memory 506 including an agent identification module 508, a video analysis module 510, a customer interaction module 512, and a feedback module 514.

The stress assessment device 116, in one embodiment, is a hardware device with at least one processor executing machine readable program instructions for analyzing received videos such that the agent's stress-level can be determined to generate feedback. Such a system may include, in whole or in part, a software application working alone or in conjunction with one or more hardware resources. Such software applications may be executed by the processors on different hardware platforms or emulated in a virtual environment. Aspects of the stress assessment device 116 may leverage off-the-shelf software available in the art, related art, or developed later.

The processor(s) 502 may include, for example, microprocessors, microcomputers, microcontrollers, digital signal processors, central processing units, state machines, logic circuits, and/or any devices that manipulate signals based on operational instructions. Among other capabilities, the processor(s) 502 are configured to fetch and execute computer readable instructions in the memory.

The interface(s) 504 may include a variety of software interfaces, for example, application programming interface; hardware interfaces, for example, cable connectors; or both. The interface(s) 504 facilitate (1) receiving the video of the region of interest on the agent's body, the customer interaction data, and agent identification data, and (2) reliably transmitting feedback to the agent device 108 and/or the supervisor device 122.

The agent identification module 508 stores different types of data to identify each of the agents, such as the agent 102, interacting with the customer 106. Examples of the data include, but are not limited to, employment data (e.g., agent name, agent employee ID, designation, tenure, experience, previous organization, supervisor name, supervisor employee ID, etc.), demographic data (e.g., gender, race, age, education, accent, income, nationality, ethnicity, area code, zip code, marital status, job status, etc.), psychographic data (e.g., introversion, sociability, aspirations, hobbies, etc.), system access data (e.g., login ID, password, biometric data, etc.) and other business-relevant data about each of the call center agents. Some embodiments may include the agent identification module 508 to store similar data for a supervisor, such as the supervisor 104.

The video analysis module 510 receives the agent's ROI video and the corresponding agent identification data from the imaging unit 120 via the agent device 108. In one embodiment, the received agent's ROI video is processed by the video analysis module 510 to isolate a bodily vascular network using various techniques known in the art, related art, or developed later. The bodily vascular network may be identified in the ROI video based on, for example, color, spatial features, material identification, and the like, to obtain a time-series signal. The obtained time-series signal is normalized and filtered to remove undesirable frequencies. The resulting time-series signal for different bodily vascular regions includes the sum total of volumetric pressure changes within those regions. Arterial pulsations include a dominant component of these signals. The time-series signal includes a PPG signal that correlates to the agent's cardiac pulse pressure wave. The PPG signal may be de-trended to remove slow non-stationary frequency components from the time-series signal such that a nearly stationary PPG signal, and hence a nearly stationary time-series signal, can be obtained.

The video analysis module 510 extracts the low frequency and high frequency components from the time-series signal over a predefined time interval. The video analysis module 510 also computes a ratio of the low and high frequency (LF/HF ratio) of the integrated power spectrum of the corresponding time-series signal. The LF/HF ratio provides a measure of the agent's estimated HRV for that predefined time interval. The estimated HRV is then used to assess the level of agent stress.

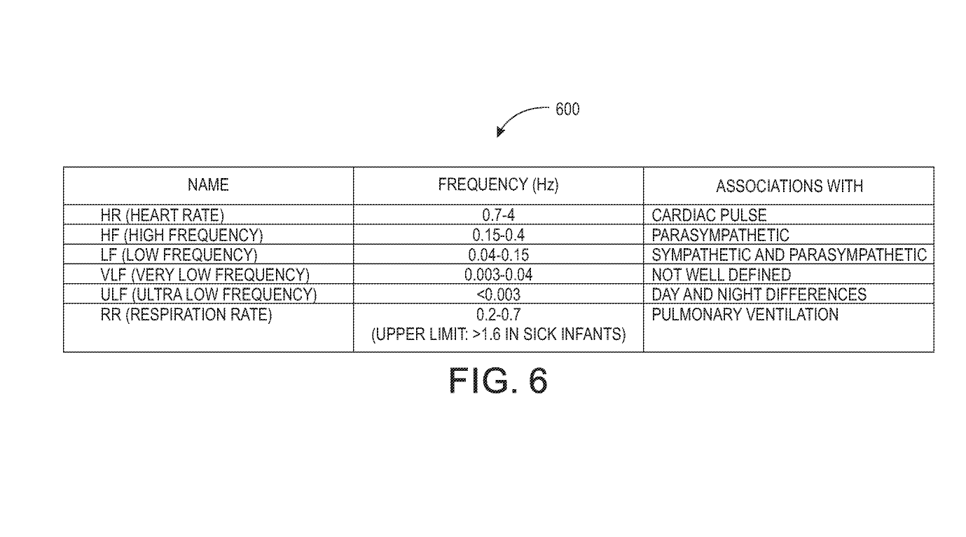

The LF and HF components are related, in different degrees, to different components of the cardio-vascular control system as shown in a table 600 (FIG. 6). The table 600 also shows different frequency components for normal healthy humans. The HF component, which has a peak at respiratory frequency, corresponds to respiratory sinus arrhythmia (RSA) and reflects parasympathetic influence on the heart through efferent vagal activity. The LF component, including fluctuations below 0.15 Hz and usually centered at about 0.1 Hz, is mediated by both cardiac vagal and sympathetic nerves. Hence, the LF/HF ratio represents the sympatho-vagal interaction. The LF and HF components may be also expressed in normalized units as shown in Equations (1) and (2) to account for inter-individual differences amongst various LF components and the HF components within their respective frequency ranges. Such normalization of the LF and HF components also normalizes the differences in various imaging units.

$$\begin{matrix}{LF}_{n} = \frac{LF}{Total Power - VLF} & ( 1 ) \\ {HF}_{n} = \frac{HF}{Total Power - VLF} & ( 2 )\end{matrix}$$

In the Equations (1) and (2), the ‘Total Power’ refers to total power of the integrated spectrum containing the LF and HF components over the predefined time interval within the time-series signal; and ‘VLF’ refers to a very low frequency ranging from 0.003 Hz to 0.04 Hz over the predefined time interval within the time-series signal.

The LF/HF ratio exceeding a value ‘1’ indicates abnormal stress-level of the agent 102. The video analysis module 510 may include multiple stress threshold values that are compared to the computed value of LF/HF ratio for determining the level of agent stress. For example, a value of the LF/HF ratio between stress threshold values ‘1’ to ‘2’ may indicate low-level stress. Similarly, a value of the LF/HF ratio between the stress threshold values ‘2’ and ‘3’ may indicate mid-level stress, and that between the stress threshold values ‘3’ and ‘4’ may indicate high-level stress experienced by the agent 102. The LF/HF ratio having a value less than the stress threshold value ‘1’ corresponds to the influence of PNS indicating insignificant or normal-level agent stress.

Such non-contact estimation of HRV based on analyses of agent's ROI video to determine agent stress does not involve active involvement of the agent 102, thereby minimizing the chances of agent pretense. This passive determination of the agent stress may be performed at night or day with or without the visible (ambient) illuminators since the imaging unit 120 can measure HR signals under IR illumination, which is not visible at night. Also, some visible illuminators (for example, incandescent lamps) have enough IR signals, and hence the imaging unit 120 in communication with the stress assessment device 116 can be used without any additional illuminators even if the analysis is required for the agent ROI video taken in dark or low-light environments.

The customer interaction module 512 receives the customer interaction data and the agent identification data from the agent device 108. The customer interaction module 512 is configured to analyze the customer interaction data including at least one of customer-related actions including: (1) the customer's responses to the IVR system; (2) the text messages, the audio interactions, and the video interactions exchanged between the customer 106 and the agent 102 (or the supervisor 104); (3) customer-provided feedback; and (4) a customer call summary created by the agent 102 based on the agent's interaction with the customer 106, or in any combination thereof. In one example, the customer interaction module 512 may apply Automatic Speech Recognition (ASR) on the agent-customer conversation followed by text analysis of the ASR transcript to parse the conversation into different categories. The categorization may be performed on the basis of different parameters such as modeling the customer call flow (for example, which part of the call was ‘greeting’, ‘query’, ‘closing’ and so on), spotting key words or generic terms of interest (for example, 16-character alphanumeric customer ID, 10-digit phone number), sentiment-intensive words (for example, ‘hate’, ‘irritate’, etc.), customer-agent voice-over (indicative of impatience and irritation on customer's side) and other finer aspects. In another example, the customer interaction module 512 may parse the customer's IVR responses to identify various aspects such as a broad topic of a customer call, the caller's state of mind (i.e., is the customer 106 agitated, in a hurry or calm), customer interaction history (i.e., number of times the customer 106 has called in the recent past, how much time the customer 106 has spent in traversing the IVR) and in many cases a fine grain sub-topic identification. The customer interaction module 512 identifies these parameters and aspects as the stress-trigger points responsible for causing agent tress.

Further, the customer interaction module 512 is configured to combine the customer interaction data with the agent stress profile determined by the video analysis module 510 based on the agent identification data. For example, customer interaction module 512 may correlate various customer-related actions with the time of high agent stress based on the agent login ID to derive insights into the stress-trigger points for the agent 102, such as, (a) the agent 102 is more stressed during a ‘query’ period (such that a likely implication is that the access to database is slow or the script to identify a customer issue is not easy to follow) or during a ‘resolution’ period (such that a likely implication is that a manual provided for troubleshooting is not detailed enough or is faulty and needs revision); (b) the agent 102 is stressed by customer's language and tone (such that a likely implication is that the agent 102 needs training on ‘how to empathize with the customer 106’ or that the call should be escalated); or (c) the agent 102 is highly stressed throughout the call (such that a likely implication is that the agent 102 has difficulty following a particular accent of the customer 106 or is not well versed in a particular customer-related topic). Such insights are also identified as the stress-trigger points for the agent 102 by the customer interaction module 512. The customer interaction module 512 communicates the stress-trigger points to the feedback module 514.

The feedback module 514 receives the stress-trigger points and is configured to provide feedback to at least one of the agent 102 and the supervisor 104 based on outputs of the video analysis module 510 and the customer interaction module 512. In one example, the feedback module 514 may generate feedback, whenever the video analysis module 510 determines that the LF/HF ratio has exceeded one or more predefined stress threshold values indicating a stress pattern of the agent 102. In another example, predefined suggestive remedial messages may be stored in the feedback module 514. The predefined suggestive remedial messages may be created based on the identified stress-trigger points. The feedback module 514 may be configured to generate feedback including the predefined suggestive remedial messages to assist in reducing agent stress.

Additionally, the identified stress-trigger points may be retrieved from the feedback module 514 upon request. The retrieved stress-trigger points may be used by the supervisor 104 or the agent 102 offline for various purposes, such as to identify a set of agents that may be best suited for a particular customer-related topic, the agents who need further training on particular customer-related topics, those customer-related topics that need better training material, and so on.

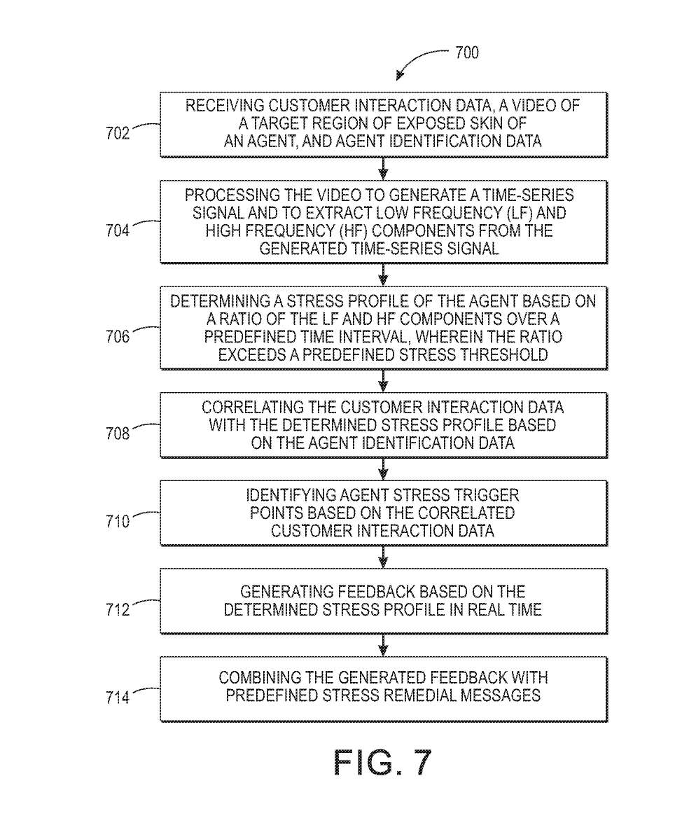

FIG. 7 illustrates an exemplary method for implementing the stress assessment device 116, according to an embodiment of the present disclosure. The exemplary method may be described in the general context of computer executable instructions. Generally, computer executable instructions can include routines, programs, objects, components, data structures, procedures, modules, functions, and the like that perform particular functions or implement particular abstract data types. The computer executable instructions can be stored on a computer readable medium, and installed or embedded in an appropriate device for execution.

The order in which the method is described is not intended to be construed as a limitation, and any number of the described method blocks can be combined or otherwise performed in any order to implement the method, or an alternate method. Additionally, individual blocks may be deleted from the method without departing from the spirit and scope of the present disclosure described herein. Furthermore, the method can be implemented in any suitable hardware, software, firmware, or combination thereof, that exists in the related art or that is later developed.

The method describes, without limitation, implementation of the exemplary stress assessment device 116 in a call center environment. One of skill in the art will understand that the method may be modified appropriately for implementation in a variety of other business scenarios including those related to medical services, hospitality, retail, banking services, and so on, without departing from the scope and spirit of the disclosure.

At step 702, customer interaction data, video of a target region of exposed skin of an agent, and agent identification data is received. In case of a call center, the customer 106 may communicate with the call center agent 102 over the communication network 112. Such communication may be established between the customer device 110 and the agent device 108 either directly or via an intermediate device such as the server 114, the network appliance 118, and so on. The customer 106 may manipulate the customer device 110 to communicate with the call center agent 102 via the agent device 108 through various modes. In a first mode, the customer 106 may communicate with the IVR system interfacing between the customer device 110 and the agent device 108. The customer 106 may respond to various pre-recorded or dynamically-generated messages in the IVR system. Based on customer responses, the IVR system may route the customer 106 to the agent 102 for direct interaction. In a second mode, the agent device 108 may be configured to establish a direct connection with customer device 110 without intervention from the IVR system.

Once the agent device 108 is connected to the customer device 110, the customer 106 may interact with the agent 102 through at least one of text messages, audio interaction data, video interaction data, or customer-provided feedback that is recorded by the agent device 108. The agent 102 may use the agent device 108 to additionally prepare a summary of the audio interactions or the video interactions conducted with the customer 106.

In a call center environment, such customer-agent interactions may be substantially predefined or scripted. For example, the agent 102 may have access to one or more scripts, for example, including dialogs and questions to ask the customer 106 during a customer call. The script may be available to the agent 102 in a physical version, such as on a physical paper, or in an electronic version stored on the agent device 108. The electronic version of the script may be hyperlinked for directing the agent 102 to other scripts based on a customer's response to a previously asked question. For this, the agent 102 may enter the customer's response into the script or an associated scripting program, such as by pressing a predetermined button on the agent device 108 or by selecting a proper response from a list using a mouse or other pointing device (input code), on the agent device 108. Depending upon the entered response, the script or the scripting program may display another script on the agent device 108.

The agent device 108 may collect the customer interaction data including the customer's IVR responses, the text messages, the audio interaction data, the video interaction data, the customer-provided feedback and the call summaries, and convey them along with the agent identification data to the stress assessment device 116. The stress assessment device 116 may be implemented as a standalone device, or integrated with at least one the agent device 108, the server 114, and the network appliance 118.

Additionally, the agent device 108 includes the imaging unit 120 that is configured to monitor and capture a video of a target region of exposed skin of the agent 102. The imaging unit 120 may include IR or NIR illuminators so that the video may be correctly captured even in dark or low light conditions. In an exemplary embodiment, the agent 102 may be continuously monitored by the imaging unit 120 that is configured to capture the video while the agent 102 is interacting with the customer 106. For example, the imaging unit 120 may capture the video of the target region of exposed skin of the agent 102 during a voice call with the customer 106. The captured video is in-sync with digitized audio data corresponding to such customer-agent interaction, thereby providing combined audio-video data for analysis. The agent device 108 communicates the captured video along with the agent identification data to the stress assessment device 116.

The stress assessment device 116 includes the agent identification module 508, the video analysis module 510, the customer interaction module 512, and the feedback module 514. The video analysis module 510 is configured to receive the captured video and the agent identification data. The customer interaction module 512 is configured to receive the customer interaction data and the agent identification data.

At step 704, the received video is processed to generate a time-series signal and to extract the LF and the HF components from the generated time-series signal. The video analysis module 510 is configured to process the received video of the target region of the exposed skin of the agent 102 to isolate blood vessels in the agent's body depicted in the video based on different parameters using various techniques known in the art. Examples of these parameters include, but not limited to, color, spatial features, material identification, and the like. The isolated blood vessels are represented in the time-series signal for different bodily vascular regions captured in the video. If the agent 102 has high bodily motion, for example, during a conversation with the customer 106, then motion isolation or motion compensation algorithms known in the art may be used to filter the time-series signal. The time-series signal includes the PPG signal having the LF and HF components. The video analysis module 510 is configured to apply appropriate hardware or software filters and extract the LF and the HF components from the integrated power spectrum of the time-series signal over a predefined interval, and computes the LF/HF ratio, which is a measure of the heart rate variability, and hence the stress, experienced by the agent 102.

At step 706, a stress profile of the agent 102 is determined based on the LF/HF ratio exceeding the predefined stress threshold. The video analysis module 510 is further configured to compare the value of LF/HF ratio to at least one predefined stress threshold value. The LF/HF ratio having a value greater than the predefined stress threshold value ‘1’ indicates that the agent 102 is under stress. In contrast, the LF/HF ratio value less than the predefined stress threshold value ‘1’ indicates that the agent 102 is experiencing no stress or normal stress that is required to keep the agent 102 active. Further, the video analysis module 510 may be configured to compare the LF/HF ratio with multiple predefined stress threshold values, each of which is equivalent to or exceeds the value T. Exemplary embodiments may include the video analysis module 510 to compare the LF/HF ratio with the stress threshold values ‘2’, ‘3’, and ‘4’ to assess the level of stress experienced by the agent 102. For example, the LF/HF ratio having a value between ‘1’ and ‘2’ may indicate low-level stress, the LF/HF ratio value between ‘2’ and ‘3’ may indicate medium-level stress, and the LF/HF ratio value between ‘3’ and ‘4’ may indicate high-level stress experienced by the agent 102.

The video analysis module 510 is also configured to identify the agent 102 based on the agent identification data received from the agent device 108. The video analysis module 510 compares the agent identification data such as the login ID, the IP address of the agent device 108, etc., with the agent information in the agent identification module 508 to identify the agent 102. The video analysis module 510 associates the identified agent 102 with the determined LF/HF ratio value to create a stress profile for that agent 102 in real-time. The agent stress profile is stored at the video analysis module 510, which communicates the agent stress profile to the customer interaction module 512 and the feedback module 514.

At step 708, the customer interaction data is correlated with the stress profile of the agent 102 based on the agent identification data. The customer interaction module 512 is configured to receive the customer interaction data and the agent identification data from the agent device 108. Similar to the video analysis module 510, the customer interaction module 512 is configured to identify the agent 102 associated with the customer interaction data by comparing the received agent identification data with the agent 102 information stored in the agent identification module 508. The customer interaction module 512 correlates the received customer interaction data with the received agent stress profile based on the agent identification data. Examples of the agent identification data may include, but are not limited to, agent 102 name, employee ID of the agent 102, IP address of the agent device 108, and so on.

At step 710, agent stress-trigger points are identified in the correlated customer interaction data. The customer interaction module 512 is configured to analyze the correlated customer interaction data to determine the agent stress-trigger points that cause the LF/HF ratio for the identified agent 102 to at least become equivalent to or exceed the value ‘1’, thereby indicating the agent 102 being abnormally stressed-out. Unlike conventional techniques, such analysis augments the agent stress profile corresponding to the agent's ROI video with the correlated customer interaction data for determining the agent stress-trigger points. The analysis may be performed in a variety of ways. In one example, the customer interaction module 512 may apply Automatic Speech Recognition (ASR) on the agent-customer conversation followed by text analysis of the ASR transcript to parse the conversation into different categories that may have caused the agent's stress to increase. The categorization may be performed on the basis of different parameters, such as those discussed above, that may have made the agent 102 to experience stress. In some embodiments, the determination of the stress-trigger points is assisted by scripted details (for example, dialogs, questions, etc.) in the customer interaction data. The customer interaction module 512 provides the identified stress-trigger points to the feedback module 514.

At step 712, feedback is generated based on the agent stress profile of the agent 102 in real-time. In one embodiment, the feedback module 514 is configured to receive the agent stress profile from the video analysis module 510. When the agent stress profile indicates that the LF/HF ratio exceeds a predefined stress threshold value, such as, ‘1’, ‘2’, and so on, the feedback module 514 is configured to provide feedback to the corresponding agent 102 or to the supervisor 104 in real-time. Other embodiments may include the feedback module 514 configured to provide the feedback to the agent 102 or the supervisor 104 multiple times if the LF/HF ratio is equivalent to or above one or more predefined stress threshold values for a predetermined time. Additionally or alternatively, the feedback module 514 may be configured to provide the feedback to the agent 102 or the supervisor 104 when the LF/HF ratio reduces below one or more predefined stress threshold values.

The feedback may be provided in various forms including, but not limited to, an alert message, an audio indication such as a beep, and a visual indication such as a blinking light, or any combination thereof. The feedback indicates that the agent 102 is experiencing stress while interacting with the customer 106. For example, when the agent 102 is communicating with an irate customer 106, the agent 102 may experience abnormal stress. Upon detecting agent stress due to an increase in the LF/HF ratio beyond ‘1’ as indicated in the agent stress profile, the feedback module 514 provides the feedback to the agent 102 and the supervisor 104 in real-time during a live customer interaction. In exemplary embodiments including those involving non-visual interactions, such as voice calls, between the agent 102 and the customer 106 in a live environment, the provided feedback assists the agent 102 to change the course of interaction whenever abnormal stress-level of the agent stress is determined. In some embodiments, the feedback module 514 may provide the feedback to the supervisor 104 on the supervisor device 122 during an on-going customer-agent interaction. As a result, the supervisor 104 is able to effectively monitor multiple customer-agent interactions and provide relevant assistance to the agent 102 for ensuring or enhancing customer satisfaction.

At step 714, the feedback is combined with suggestive stress-remedial messages based on the identified stress-trigger points. The feedback module 514 receives the stress-trigger points from the customer interaction module 512. In one embodiment, the feedback module 514 is configured to provide predefined stress remedial messages with the feedback to the agent 102 based on the received stress-trigger points. The predefined stress remedial messages may assist the agent 102 during the live customer interaction to reduce agent stress. For example, the agent 102 may be experiencing stress due to lack of adequate information to address customer 106 needs. In response to an increasing agent stress, the feedback module 514 may provide the agent 102 with a link to a technical guide along with stress-indicating feedback to assist the agent 102 on-the-fly to successfully address the customer 106 needs and reduce agent stress. In another example, if the agent stress-level remains above the predefined stress threshold for a predefined duration during the customer call, the supervisor 104 may be alerted by sending feedback or the agent 102 may be prompted to escalate the call. Unlike the conventional offline analyses of the customer interaction data, the feedback module 514 analyzes the stress-trigger points to provide real-time appropriate feedback message during a live customer-agent interaction for mitigating agent stress and enhance customer satisfaction.

Other embodiments may include the feedback module 514 configured to provide stress-related data for each agent 102 on-demand for non-continuous monitoring of customer-agent interactions. In one example, the supervisor 104 may request for the agent stress-trigger points for a particular agent 102 across various customer calls to perform an aggregate-level stress analysis for the agent 102. In another example, the supervisor 104 may request for stress-trigger points across a set of agents to identify high stress times and high stress agents for managing deputation of one or more supervisors. Such analysis of the stress-related data may assist the supervisor 104 to monitor long-term performance of one or more agents to improve call routing and to improve various resources, such as training, learning material, number of breaks, allocated projects of a particular type, etc., available to the agents.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

What is claimed is:

1. A system to assess stress of a first party, comprising:
an imaging source which captures image data of a target region of exposed skin of the first party;
a recording device which collects interaction data of at least one interaction between the first party and a second party; and
a stress assessment device, wherein the stress assessment device:
(a) receives the captured image data and the collected interaction data;
(b) estimates the first party's stress-level based on the received image data; and
(c) generates information regarding the first party based on the estimated stress level of the first party.

2. The system of claim 1, wherein the generated information is further based on the correlation of the received interaction data with the estimated stress-level of the first party.

3. The system of claim 1, wherein the estimated first party's stress-level is estimated in real-time.

4. The system of claim 1, wherein the generated feedback is provided to the first party in real-time.

5. The system of claim 1, wherein the stress assessment device further:
generates a time-series signal from the captured video, wherein the time-series signal includes at least one low frequency (LF) component and at least one high frequency (HF) component in the integrated power spectrum of the time-series signal over a predefined interval;
computes a ratio of the at least one LF component and the at least one HF component; and
estimates stress of the first party based on the computed ratio.

6. The system of claim 5, wherein the predefined stress threshold has one or more values, wherein at least one value of the predefined stress threshold is equal to one.

7. The system of claim 5, wherein the ratio detects heart rate variability of the first party.

8. The system of claim 1, wherein the stress assessment device further: determines the first party's stress-trigger points based on the received interaction data.

9. The system of claim 1, wherein the stress assessment device further: generates a stress profile of the first party using the estimated first party's stress-level.

10. The system of claim 1, wherein the received interaction data is correlated with the estimated first party's stress-level based on identification data of the first party.

11. The system of claim 1, wherein the recording device further:
generates identification data of the first party; and
communicates the generated first party's identification data to the stress assessment device.

12. The system of claim 11, wherein the identification data includes at least one of a system login ID, system password, biometric data, name, and employee ID.

13. The system of claim 1, wherein the generated feedback includes at least one of a message, an audio indication, and a visual indication.

14. The system of claim 1, wherein the generated feedback includes at least one predefined stress remedial message.

15. The system of claim 1, wherein the interaction data includes at least one of a response to an interactive voice response (IVR) system, an audio interaction, a video interaction, a text message, a call summary, and second party-provided feedback, wherein the audio interaction includes at least one of a voice call and a recorded audio message, and the video interaction includes at least one of a video call and a recorded video message.

16. The system of claim 1, wherein the first party is a first human and the second party is a second human.

17. A stress assessment device comprising at least one computer module having instructions stored in a memory of the device, the instructions of the computer module which when executed by a processor of the device:
(i) receives image data of a target region of exposed skin of a first party;
(ii) estimates stress-level of the first party based on the received image data;
(iii) receives interaction data collected based on at least one interaction between the first party and a second party;
(iv) correlates the received interaction data with the estimated stress-level of the first party; and
(v) generates information regarding the first party based on the correlation of the received interaction data with the estimated stress-level of the first party.

18. The stress assessment device of claim 17, wherein the instructions of the at least one module which when executed by the processor of the device further:
generates a time-series signal from the received video, wherein the time-series signal includes at least one low frequency (LF) component and at least one high frequency (HF) component in the integrated power spectrum over the predefined interval;
computes a ratio of the at least one LF component and the at least one HF component; and
estimates stress-level based on the computed ratio.

19. The stress assessment device of claim 17, wherein the instructions of the at least one module which when executed by the processor of the device further determines stress-trigger points from the received interaction data of the first party.

20. A method to stress assess a first party comprising:
receiving image data of a target region of exposed skin of an first party;
estimating stress-level of the first party based on the received image data;
receiving interaction data collected based on at least one interaction between the first party and a second party;
correlating the received interaction data with the estimated stress-level of the first party; and
generating information regarding the first party based on the correlation of the received interaction data with the estimated stress-level of the first party.

21. The method to stress assessment of claim 20 further comprising:
processing the image data to: (i) generate a time-series signal; and (ii) extract low frequency components and high frequency components from the generated time-series signal;
determining a stress profile of the first party based on a ratio of the low frequency components and the high frequency components;
correlating the received interaction data with the determined stress profile; and
identifying at least one stress-trigger point of the first party based on the correlating of the received interaction data with the determined stress profile.

22. A system to assess stress in an first party, comprising: a stress assessment device;
a recording device to record: (i) video data of a target region of exposed skin of the first party and (ii) interaction data from an interaction between the first party and a second party; and
a communication path which enables electronic communication of the video data and the interaction data to the stress assessment device wherein the stress assessment device:
estimates the first party's stress-level based on the video data and the interaction data; and
generates feedback regarding the first party based on the estimated stress-level.
